(19) United States
(12) Patent Application Publication
(10) Pub. No.: US 2021/0264283 A1
(43) Pub. Date: Aug. 26, 2021

(54) DATASET CREATION FOR DEEP-LEARNING MODEL

(71) Applicant: International Business Machines Corporation, Armonk, NY (US)

(72) Inventors: Srikanth Govindaraj Tamilselvam, Chennai (IN); Senthil Kumar Kumarasamy Mani, Bangalore (IN); Jassimran Kaur, Chandigarh (IN); Utkarsh Milind Desai, Bangalore (IN); Shreya Khare, Bangalore (IN); Anush Sankaran, Kothnur (IN); Naveen Panwar, Bangalore (IN); Akshay Sethi, Ontario (CA)

(21) Appl. No.: 16/798,757

(22) Filed: Feb. 24, 2020

(51) Int. Cl. G06N 3/08; G06N 3/04

(52) U.S. Cl. CPC G06N 3/086; G06N 3/04

(57) ABSTRACT

One embodiment provides a method, including: receiving a training dataset to be utilized for training a deep-learning model; identifying a plurality of aspects of the training dataset, wherein each of the plurality of aspects corresponds to one of a plurality of categories of operations that can be performed on the training dataset; measuring, for each of the plurality of aspects, an amount of variance of the aspect within the training dataset; creating additional data to be incorporated into the training dataset, wherein the additional data comprise data generated for each of the aspects having a variance less than a predetermined amount, wherein the data generated for an aspect results in the corresponding aspect having an amount of variance at least equal to the predetermined amount; and incorporating the additional data into the training dataset.

### BACKGROUND

Deep learning models are a type of machine learning model whose training is based upon learning data representations as opposed to task-specific learning. In other words, deep or machine learning is the ability of a computer to learn without being explicitly programmed to perform some function. Thus, machine learning allows a programmer to initially program an algorithm that can be used to predict responses to data, without having to explicitly program every response to every possible scenario that the computer may encounter. In other words, machine learning uses algorithms that the computer uses to learn from and make predictions with regard to data. Machine learning provides a mechanism that allows a programmer to program a computer for computing tasks where design and implementation of a specific algorithm that performs well is difficult or impossible. To implement machine learning, models or training datasets are created to train the machine-learning model. As the machine-learning model is presented with more and more data, the model is able to make predictions with respect to new data that the model has never digested or seen before.

### BRIEF SUMMARY

In summary, one aspect of the invention provides a method, comprising: receiving a training dataset to be utilized for training a deep-learning model; identifying a plurality of aspects of the training dataset, wherein each of the plurality of aspects corresponds to one of a plurality of categories of operations that can be performed on the training dataset; measuring, for each of the plurality of aspects, an amount of variance of the aspect within the training dataset; creating additional data to be incorporated into the training dataset, wherein the additional data comprise data generated for each of the aspects having a variance less than a predetermined amount, wherein the data generated for an aspect results in the corresponding aspect having an amount of variance at least equal to the predetermined amount; and incorporating the additional data into the training dataset.

Another aspect of the invention provides an apparatus, comprising: at least one processor; and a computer readable storage medium having computer readable program code embodied therewith and executable by the at least one processor, the computer readable program code comprising: computer readable program code configured to receive a training dataset to be utilized for training a deep-learning model; computer readable program code configured to identify a plurality of aspects of the training dataset, wherein each of the plurality of aspects corresponds to one of a plurality of categories of operations that can be performed on the training dataset; computer readable program code configured to measure, for each of the plurality of aspects, an amount of variance of the aspect within the training dataset; computer readable program code configured to create additional data to be incorporated into the training dataset, wherein the additional data comprise data generated for each of the aspects having a variance less than a predetermined amount, wherein the data generated for an aspect results in the corresponding aspect having an amount of variance at least equal to the predetermined amount; and computer readable program code configured to incorporate the additional data into the training dataset.

An additional aspect of the invention provides a computer program product, comprising: a computer readable storage medium having computer readable program code embodied therewith, the computer readable program code executable by a processor and comprising: computer readable program code configured to receive a training dataset to be utilized for training a deep-learning model; computer readable program code configured to identify a plurality of aspects of the training dataset, wherein each of the plurality of aspects corresponds to one of a plurality of categories of operations that can be performed on the training dataset; computer readable program code configured to measure, for each of the plurality of aspects, an amount of variance of the aspect within the training dataset; computer readable program code configured to create additional data to be incorporated into the training dataset, wherein the additional data comprise data generated for each of the aspects having a variance less than a predetermined amount, wherein the data generated for an aspect results in the corresponding aspect having an amount of variance at least equal to the predetermined amount; and computer readable program code configured to incorporate the additional data into the training dataset.

A further aspect of the invention provides a method, comprising: receiving (i) a dataset used with a machine-learning model and (ii) a purpose of the machine-learning model; identifying dimensions of the dataset, wherein each of the dimensions corresponds to a feature of the dataset; measuring, utilizing at least one heuristic, variability in each of the dimensions across the dataset; identifying, from the dimensions, non-variable dimensions comprising dimensions having variability less than a predetermined amount, wherein the predetermined amount for each of the dimensions is based upon the purpose of the machine-learning model, the purpose requiring less variability for at least a subset of the dimensions than for another subset of the dimensions; and augmenting the dataset for each non-variable dimension such that the non-variable dimension, after augmentation, has a variability at least equal to the predetermined amount across the dataset.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of generating a dataset for a deep-learning model by augmenting a training dataset to ensure sufficient variability across the dataset.

FIG. 2 illustrates an example system architecture for generating a dataset for a deep-learning model by augmenting a training dataset to ensure sufficient variability across the dataset.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

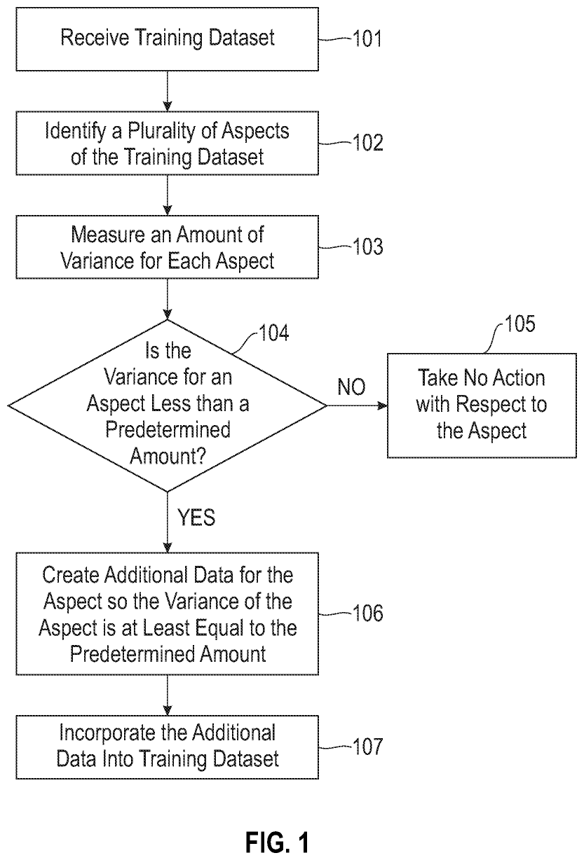

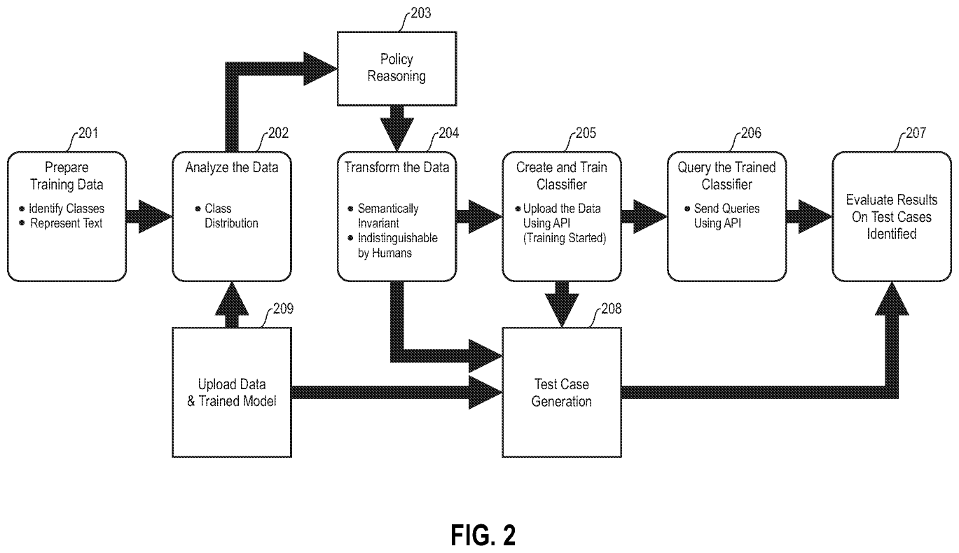

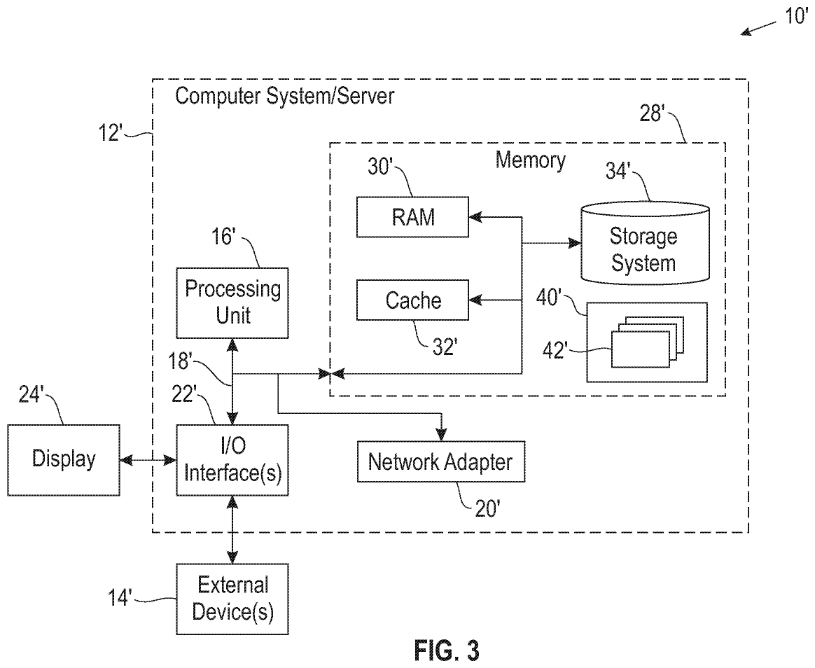

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

Training datasets are created to train a machine-learning model, also referred to as a deep-learning model. The training datasets include data and an indication of the desired result corresponding to the data. For example, if the machine-learning model is an image classifier, the training dataset will include images and a classification of the images. As an example, if the machine-learning model is to identify types of animals within images, one piece of training datum may be an image of a horse that is labeled or annotated as such. Including different images of horses within the training dataset will allow the machine-learning model to identify characteristics of horses that allow the machine-learning model to accurately identify images of horses even if the machine-learning model has not previously been presented with that image.

The problem with the training datasets is that compiling the training datasets is very time intensive. Additionally, the training datasets frequently lack diversity across dimensions or aspects of the training dataset. For example, in the example case of images, the images included in the training dataset may all be roughly the same view of the animal, for example, the images may show the entire animal. Thus, when the machine-learning model is presented with an image of a different view of the animal, for example, a close-up or just a portion of the animal, the machine-learning model may inaccurately predict or classify the image, also referred to as the machine-learning model failing. A lack of diversity across the training dataset results in a deep-learning model that fails upon exposure to a piece of information that is a variation of the dataset. In other words, if the machine-learning model is trained using data that is very similar, when the machine-learning model receives data with slight variations it will incorrectly classify that data, thereby failing.

Accordingly, there have been efforts to automate, at least partially, the creation of the training datasets. The automated process generally takes a compiled training dataset and then augments the data within the dataset to generate a new training dataset that can be incorporated into the training dataset used for training the machine-learning model. The augmentation changes the data in a manner that is consistent with the purpose of the machine-learning model but that also provides diversity in the data included in the training dataset. The problem with this automation is that the current automation systems augment all of the data included in the training dataset. In other words, the current systems augment the data across all dimensions or aspects of the dataset. While this does produce a training dataset that is augmented and increases the diversity of the data included in the training dataset, augmenting all of the data requires large amounts of processing and computing resources and also takes a significant length of time, for example, many hours or even days depending on how large the training dataset is. Much of the resources and time is spent augmenting data that may not need to be augmented. In other words, the current systems do not intelligently or systematically augment the data. Rather, the current systems augment all the data without any regard to whether a particular dimension of the dataset needs to be augmented.

Accordingly, an embodiment provides a system and method for generating a dataset for a deep-learning model by augmenting a training dataset to ensure sufficient variability across the dataset. The system receives a training dataset to be utilized for training a deep-learning model. The system may also receive an identification of the task or purpose of the deep-learning model. The system identifies a plurality of aspects or dimensions within the dataset. An aspect or dimension corresponds to a category of operations that can be performed on the training dataset. For example, in an image dataset, one aspect or dimension may be a geometric transformation that identifies an orientation of the image or objects within the image. Operations that transform the orientation of the image or objects within the image would correspond to the geometric transformation aspect or dimension. For each aspect or dimension, the system measures an amount of variance of the aspect across or within the training dataset. In other words, the system determines how much variation with respect to the aspect exists within the training dataset. Measuring the amount of variance or variability can be performed using one or more heuristics, which may be unique to an aspect.

Once the system has identified the amount of variance or diversity for each aspect, the system compares the measurement to a predetermined amount. The predetermined amount may vary across aspects. In other words, the variability of each aspect is not necessarily compared to the same predetermined amount. One factor that may cause variation in the predetermined amounts is the task of the deep-learning model. For different tasks, the amount of diversity of particular aspects may vary. For example, for one task the amount of diversity for one aspect may be very little, whereas, for another task, the amount of diversity for that same aspect may be significant. For each aspect that is identified as having a variance less than the predetermined amount for that aspect, the system will create additional data so that the aspect has a variance at least equal to the predetermined amount. Once the additional data has been created, the additional data will be incorporated into the training dataset.

Such a system provides a technical improvement over current systems for generation of deep-learning model datasets. In contrast to conventional systems for automated training dataset generation, the described system and method provides a technique that allows for structured generation of training datasets. Instead of augmenting all data included in a training dataset, the described system and method identify the aspects or dimensions of the dataset that do not have enough variance or diversity and only augments the data for those dimensions, thereby greatly reducing the amount of data that needs to be augmented. Thus, the system requires less processing resources and time than the conventional systems. The decrease in the amount of time and processing resources allows for generation of training dataset much more quickly than the conventional techniques. Additionally, the generated training dataset can be used to test for the robustness of a deep-learning model, whereas, using conventional systems, only the accuracy of the model is tested.

FIG. 1 illustrates a method for generating a dataset for a deep-learning model by augmenting a training dataset to ensure sufficient variability across the dataset. At 101, the system may receive a training dataset. The training dataset is a dataset that is used for training a deep-learning model. Unlike conventional techniques which are used only on images, the described system and method can be utilized on models that process images, text, audio, or the like. Thus, the training dataset can be data of any modality (e.g., text, images, audio, video, etc.). Generally speaking, the training dataset is utilized for training a specific deep-learning model type. In other words, the training dataset has already been designated for a specific deep-learning model, or at least specified for a deep-learning model having a particular purpose. As an example, if the deep-learning model is programmed to classify images, the training dataset may include a plurality of images that have been annotated or labeled with the correct classification. As another example, if the deep-learning model is programmed to analyze text sentiment, the training dataset may include a plurality of words, phrases, sentences, or other textual information that are annotated or labeled with the correct sentiment.

Accordingly, with receipt of the training dataset, the system may also receive an indication of the task or purpose of the deep-learning model. A task or purpose of a deep-learning model indicates what the deep-learning model is programmed to accomplish. For example, a deep-learning model task or purpose may be input classification, input analysis, and the like. Receipt of the training dataset and/or task identification may be by way of a person or user uploading the information to the system. A user may also provide a pointer or link to the location of the information for the system to retrieve therefrom. Additionally or alternatively, the information may be stored in a data storage location that the system has access to and the system can then pull the necessary information from the data storage location.

At 102, the system may identify a plurality of aspects of the training dataset. An aspect of the training dataset is a dimension or feature of the training dataset. Each aspect can be categorized within one of a plurality of categories. These categories then correspond to different operations that can be performed on the training dataset to result in augmented data. For example, within images, operation categories may include geometric operations (e.g., mirror, flip, rotate, shear, shift, etc.), frequency operations (e.g., equalize, sharpen, blur, contrast, etc.), color operations (e.g., posterize, colorize, invert, etc.), size operations (e.g., cutout, expand, crop, zoom, etc.), and the like. As another example, within text, operation categories may include character operations (e.g., character cases, transposition of characters, spelling errors, stroke changes, etc.), word operations (e.g., conversion of number to words, synonyms, homophones, abbreviations, etc.), phrase/sentence operations (e.g., paraphrasing sentences, change of voice, etc.), paragraph or document operations (e.g., addition of sentences to paragraphs, utilizing previous version of a document, etc.), and the like.

In other words, the aspect is a category of objectives or changes that can be made to an object included in the training dataset. Each change to an object within the training dataset can be identified. That change can then be categorized into a particular aspect. The aspects may change based upon the purpose or task of the deep-learning model. For example, a deep-learning model that is intended to perform text sentiment analysis may have aspects different than those of a deep-learning model that is intended to classify text into entity categories.

At 103, the system may measure an amount of variance, variability, or diversity for each aspect within the training dataset. The variance indicates how much the aspect varies across the training dataset. In other words, the variance identifies an amount of similarity between the data included within the training dataset with respect to a particular aspect. If the training dataset includes data that has low diversity with respect to a particular aspect, when the deep-learning model is presented with an object that is different than the training dataset, then the deep-learning model may incorrectly classify or analyze the object. To measure the variance the system may utilize one or more heuristics that are designed to measure a particular aspect. For example, the system may be specifically programmed with a heuristic that can measure an amount of variance in the formality of text. The system may also utilize known measurement techniques, for example, similarity measures, cosine similarity, clustering techniques, affinity measurements, class distribution measures, and the like.

The purpose of the deep-learning model may govern whether a particular aspect needs to have a particular variance or not. For example, if the deep-learning model is intended to classify images and the training dataset has little variance regarding the orientation of the images, when the deep-learning model is presented with an image that has a different orientation, the deep-learning model may incorrectly classify the image. On the other hand, assuming the same purpose of classifying images, if the training dataset has very little variance with respect to the background but the foreground varies, the little variance with respect to the background may make no difference with regards to whether the deep-learning model can accurately classify the foreground of the image. Accordingly, measurement of the variance can occur for each aspect within the training dataset. Alternatively, measurement of the variance may only occur for those aspects that require variance. In other words, depending on the purpose of the model, some aspects may not need variance, therefore, in order to reduce processing and time, the system may not measure the variance for those aspects whose variance is not important.

Another technique for determining if a particular aspect needs to be augmented is by using an augmentation policy approximator. In this technique the system extracts features from the dataset, for example, using image feature extraction techniques, text feature extraction techniques, or the like. The system then combines these features into an ensemble and classifies these features. The classifier ensemble is used to compare the current dataset to other datasets to identify other datasets that may be similar to the current dataset. The other datasets include datasets that have already been augmented. In other words, the other datasets include historical datasets. The system may use one or more similarity measure techniques to determine the similarity of one dataset to another dataset. The output of this is an identification of the dataset(s) that is most similar to the current dataset. Since the historical dataset has already been augmented, the system can identify which aspects of the historical dataset were augmented. Using this information, the system can start by assuming that the aspects that were augmented in the historical dataset likely will need to be augmented in the current dataset to result in the desired variance. This technique reduces the processing time needed for performing the augmentation.

Since the system determines the variance of each aspect across the training dataset, the system can then determine which aspects need additional variance. Accordingly, the system may determine, at 104, if the variance for a particular aspect is less than a predetermined amount. To make the determination of whether the aspect has a variance less than a predetermined amount, the system may take the variance measurement that was measured at 103 and compare it to the predetermined amount.

The predetermined amount may vary depending on the aspect. For example, one aspect of the deep-learning model may need to have a large variance across the training dataset, whereas another aspect only needs a small variance across the training dataset. The predetermined amount may be programmed by a user or may be a default value. Alternatively, the predetermined amount may be based upon historical data or crowd-sourced information. For example, if the system has access to other training datasets for other deep-learning models, the system may determine the variance in aspects for those training datasets. The system may then determine the variance value for aspects of training datasets that are similar to the current training dataset. The system may also utilize user provided information to modify predetermined value thresholds. For example, the system may create a default value based upon historical or crowd-sourced information and then receive user input modifying that value or indicating that a particular aspect should have an increased or decreased variance.

If the variance for a particular aspect across the training data is not less than the predetermined amount, the system may take no action with respect to that aspect at 105. Since the system does not take any action with respect to aspects having an acceptable variance (i.e., a variance equal to or greater than the predetermined amount), the described system greatly reduces the search space, processing resources, and time necessary for augmenting the data as compared to conventional systems which augment the data for all aspects regardless of the existing variance in the training dataset. In other words, by only taking an action, specifically creating additional data, with respect to only those aspects having a variance less than the predetermined amount, the system greatly reduces the processing and computation time as opposed to conventional techniques that augment data or create additional data for all aspects regardless of the amount of variance within the aspect across the dataset.

If, on the other hand, the system determines that a particular aspect has a variance less than the predetermined amount, the system creates additional data for that aspect at 106. Creation of the additional data includes augmenting the data with respect to the identified aspect. Generally, augmenting the data occurs for each aspect individually which allows for greater diversity in the training dataset when all the augmented data is collated. In this scenario, as an example, a particular datum included in the training dataset may be augmented five different times, five different ways, because five different aspects need to be augmented. However, the system could also identify all aspects that have a variance less than the predetermined amount and augment the data for all aspects at the same time. In this scenario, as an example, a particular datum included in the training dataset may only be augmented once, even if five different aspects associated with the datum need to be augmented.

When the additional data are created for each aspect, the system generates data that result in the aspect having a variance at least equal to the predetermined amount. In other words, the system will vary the aspect within the training data until the predetermined amount corresponding to that aspect is either reached or exceeded. The system may be able to identify, based upon the measured variance, how much the data need to be augmented. Alternatively, the system may augment the data with respect to the identified aspect and then take an additional variance measurement. If the variance measurement still does not meet the predetermined amount, the system may make another augmentation to the data. This process may iterate until the predetermined amount is reached or exceeded. Even in the case where the system may estimate how much the data need to be varied, the system may still make a variance measurement after the augmentation is complete in order to make sure that the predetermined amount has been reached or exceeded.

When augmenting the data or creating the additional data, the system intelligently transforms or augments the data. Specifically, the system makes sure that the augmented data are transformed in a manner that ensures that the deep-learning model will perform as designed. For example, if the system needs to augment text data and the semantics of the text data is important to the operation of the deep-learning model, the system will ensure that a semantic similarity with respect to the original testing dataset is maintained. Thus, determining how the data should be transformed or augmented may also be based upon the purpose or task of the deep-learning model.

Once the additional data are created, the additional data are incorporated into the training dataset. In the case that additional data were created for each aspect, all of the additional data will be collated and incorporated into the training dataset. In the case that additional data were created for all of the aspects at once, the additional data will be incorporated into the training dataset. Additional data may also be created as a combination of individual aspects and combined aspects. For example, the system may combine a few aspects together and create a single additional dataset for those aspects and may also create additional datasets for other individual aspects. Incorporation into the training dataset may include replacing either a subset or all of the training dataset with the additional data, or may include adding the additional data into the training dataset. Incorporation may also include a combination thereof where some of the additional data replace portions of the training dataset and some of the additional data are added to the training dataset.

The modified training dataset (i.e., the training dataset with the additional data) can also be used to test or evaluate the deep-learning model. Since the modified training dataset includes data that is diverse, particularly with respect to identified aspects, the diverse data can be used to test and evaluate a deep-learning model instead of or before using the training dataset to train the model. By using the dataset having aspects that are known to be diverse, the deep-learning model can be tested for robustness. In other words, the modified training dataset can be used to identify if the deep-learning model can accurately classify or analyze the modified training dataset and, specifically, identify if the deep-learning model can accurately classify or analyze diverse data. After the modified training dataset is presented to the deep-learning model for testing the model, the results can be evaluated to determine whether the model failed or what aspects the model failed with respect to. Thus, this testing tests the robustness of the model which indicates how likely the model is to fail when presented with different data.

To evaluate the model, the system may define multiple objectives to generate the test cases. These objectives may identify or indicate how the model should perform when presented with diverse data. For example, some objectives may include an average error rate for labels, a classification error rate for particular aspects, a tolerance level of misclassifications, a similarity measure, and the like. The results from the model can then be evaluated against each of the multiple objectives. If the modified training dataset is to be used to test the model, the system may weight different aspects or data transformations in order to generate the test cases. The system may then use an algorithm based upon the weighted transformations to generate the test cases. For example, the system may use a multi-genetic algorithm based algorithm for generating the test cases. This type of algorithm, and other known algorithms, formulate perturb subroutines to generate new samples from the training dataset. The training dataset is then modified utilizing the subroutine until convergence. This modified training dataset can then be used to test and evaluate the model against the defined objectives.

Additionally, since the described system allows for testing and evaluation of the model, the system also introduces explainability into the system. Explainability is the concept of being able to explain why the model behaved in a particular manner, why the model failed with respect to a particular aspect, whether the model is functioning as expected when presented with a diverse dataset, and the like. Since the system has an understanding of the dataset and the diversity of different aspects of the dataset, the system is able to identify the cause of a result of the model. Since the system can identify the cause of a result, the system can also provide an explanation describing factors of the model that resulted in the returned evaluation, for example, the determined robustness, the failure with respect to a particular aspect, or the like.

FIG. 2 illustrates an example overall system architecture of the described system and method. At 201 the system prepares the training data by identifying different classes (also referred to as aspects or dimensions) included in the training dataset. The system also represents text, in the case that the training dataset is a text dataset. At 202 the system analyzes the data to identify a class distribution or a variance in the data for particular classes. The analysis at 202 may also use uploaded data and the trained model from 209. Using the identified class distributions the system is able to generate policies through policy reasoning at 203. The policies identify which aspects or classes of the training data need to be augmented to result in a desired variance or distribution for that class. Using the policies, the system transforms the data at 204. Depending on the purpose of the model, the system may transform the data while ensuring that the data are semantically invariant and indistinguishable by humans.

If the transformed data are to be used to train the model, the system creates and trains the classifier/model at 205. In this creation and training, the data are uploaded to the model using an application programming interface (API). Once the classifier is trained, the system queries the classifier using augmented data at 206 through an API. The query results can then be evaluated at 207. If, on the other hand, the transformed data are to be used to test the model, the system uses the data transformed at 204 to generate test cases at 208. Generation of the test cases may include using data that are uploaded and the trained model 209. Once the test cases are generated, the system may test the model and evaluate the model using the generated test cases at 207.

Such a system and method provide a technical improvement over current techniques for generating machine-learning testing datasets. The described system uses a structured and systematic approach to augmenting the dataset. Rather than augmenting all data within the dataset, the described system and method only augments data within the dataset that are not diverse enough with respect to the machine-learning model. By reducing the amount of data that needs to be augmented, the described system and method require significantly less processing resources than conventional techniques. Additionally, the length of time required to create the augmented testing dataset is significantly reduced as compared with the conventional techniques. Thus, the described system is less resource and time intensive than conventional systems and techniques. Additionally, since the described system analyzes the diversity of the data with respect to each aspect of the dataset, the system can ensure that each aspect is sufficiently diverse with respect to the purpose of the deep-learning model. Since conventional systems augment all data within the training dataset, the conventional system is unable to ensure that the resultant training dataset has sufficient diversity. Thus, the described system additional ensures sufficient diversity within the training dataset that is not necessarily ensured by the conventional techniques.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
receiving a training dataset to be utilized for training a deep-learning model;
identifying a plurality of aspects of the training dataset, wherein each of the plurality of aspects corresponds to one of a plurality of categories of operations that can be performed on the training dataset;
measuring, for each of the plurality of aspects, an amount of variance of the aspect within the training dataset;
creating additional data to be incorporated into the training dataset, wherein the additional data comprise data generated for each of the aspects having a variance less than a predetermined amount, wherein the data generated for an aspect results in the corresponding aspect having an amount of variance at least equal to the predetermined amount; and
incorporating the additional data into the training dataset.

2. The method of claim 1, comprising receiving, in addition to the training dataset, a task to be performed by the deep-learning model.

3. The method of claim 1, wherein the creating additional data comprises creating additional aspect data for each of the aspects measured as having a variance less than the predetermined amount and combining the additional aspect data into the additional data.

4. The method of claim 1, wherein data within the training dataset corresponding to an aspect having a variance at least equal to the predetermined amount are not modified.

5. The method of claim 1, comprising testing the deep-learning model using the training dataset having the additional data and evaluating results returned from the deep-learning model to determine robustness of the deep-learning model.

6. The method of claim 5, wherein the evaluating comprises defining multiple objectives for the deep-learning model and evaluating the results against each of the multiple objectives.

7. The method of claim 5, wherein the testing comprises utilizing a multi-genetic algorithm to generate test cases from the training data for the testing.

8. The method of claim 5, comprising providing an explanation describing factors of the deep-learning model that result in the determined robustness of the deep-learning model.

9. The method of claim 1, wherein the creating additional data comprises augmenting the training data with respect to each of the aspects having a variance less than a predetermined amount and wherein the incorporating comprises replacing data corresponding to the aspects having a variance less than a predetermined amount with the augmented training data.

10. The method of claim 1, wherein the training dataset comprises textual data.

11. An apparatus, comprising:
at least one processor; and
a computer readable storage medium having computer readable program code embodied therewith and executable by the at least one processor, the computer readable program code comprising:
computer readable program code configured to receive a training dataset to be utilized for training a deep-learning model;
computer readable program code configured to identify a plurality of aspects of the training dataset, wherein each of the plurality of aspects corresponds to one of a plurality of categories of operations that can be performed on the training dataset;
computer readable program code configured to measure, for each of the plurality of aspects, an amount of variance of the aspect within the training dataset;
computer readable program code configured to create additional data to be incorporated into the training dataset, wherein the additional data comprise data generated for each of the aspects having a variance less than a predetermined amount, wherein the data generated for an aspect results in the corresponding aspect having an amount of variance at least equal to the predetermined amount; and
computer readable program code configured to incorporate the additional data into the training dataset.

12. A computer program product, comprising:
a computer readable storage medium having computer readable program code embodied therewith, the computer readable program code being executable by a processor and comprising:
computer readable program code configured to receive a training dataset to be utilized for training a deep-learning model;
computer readable program code configured to identify a plurality of aspects of the training dataset, wherein each of the plurality of aspects corresponds to one of a plurality of categories of operations that can be performed on the training dataset;
computer readable program code configured to measure, for each of the plurality of aspects, an amount of variance of the aspect within the training dataset;
computer readable program code configured to create additional data to be incorporated into the training dataset, wherein the additional data comprise data generated for each of the aspects having a variance less than a predetermined amount, wherein the data generated for an aspect results in the corresponding aspect having an amount of variance at least equal to the predetermined amount; and
computer readable program code configured to incorporate the additional data into the training dataset.

13. The computer program product of claim 12, wherein the creating additional data comprises creating additional aspect data for each of the aspects measured as having a variance less than the predetermined amount and combining the additional aspect data into the additional data.

14. The computer program product of claim 12, wherein data within the training dataset corresponding to an aspect having a variance at least equal to the predetermined amount are not modified.

15. The computer program product of claim 12, comprising testing the deep-learning model using the training dataset having the additional data and evaluating results returned from the deep-learning model to determine robustness of the deep-learning model.

16. The computer program product of claim 15, wherein the evaluating comprises defining multiple objectives for the deep-learning model and evaluating the results against each of the multiple objectives.

17. The computer program product of claim 15, wherein the testing comprises utilizing a multi-genetic algorithm to generate test cases from the training data for the testing.

18. The computer program product of claim 15, comprising providing an explanation describing factors of the deep-learning model that result in the determined robustness of the deep-learning model.

19. The computer program product of claim 12, wherein the creating additional data comprises augmenting the training data with respect to each of the aspects having a variance less than a predetermined amount and wherein the incorporating comprises replacing data corresponding to the aspects having a variance less than a predetermined amount with the augmented training data.

20. A method, comprising:
receiving (i) a dataset used with a machine-learning model and (ii) a purpose of the machine-learning model;
identifying dimensions of the dataset, wherein each of the dimensions corresponds to a feature of the dataset;
measuring, utilizing at least one heuristic, variability in each of the dimensions across the dataset;
identifying, from the dimensions, non-variable dimensions comprising dimensions having variability less than a predetermined amount, wherein the predetermined amount for each of the dimensions is based upon the purpose of the machine-learning model, the purpose requiring less variability for at least a subset of the dimensions than for another subset of the dimensions; and
augmenting the dataset for each non-variable dimension such that the non-variable dimension, after augmentation, has a variability at least equal to the predetermined amount across the dataset.
